(19) United States
(12) Patent Application Publication
(10) Pub. No.: US 2019/0132646 A1
(43) Pub. Date: May 2, 2019

(54) REAL-TIME MOVIE VIEWER ANALYSIS SYSTEM

(71) Applicant: International Business Machines Corporation, Armonk, NY (US)

(72) Inventors: Harish Bharti, Pune (IN); Abhay K. Patra, Pune (IN); Sarbajit K. Rakshit, Kolkata (IN); Sandeep Sukhija, Reading (GB)

(21) Appl. No.: 15/794,881

(22) Filed: Oct. 26, 2017

(51) Int. Cl. H04N 21/466; H04N 21/4223

(52) U.S. Cl. CPC H04N 21/4666; H04N 21/4223; H04N 21/4668

(57) ABSTRACT

A system, method and program product for analyzing viewer reactions watching a movie. A system is disclosed that includes a theater having a plurality of seats, wherein each seat includes an associated reaction collection system for capturing reaction information using multiple sensor inputs for a viewer watching a movie; a system for identifying sentiment data from the reaction information for a plurality of viewers; a system for time synchronizing sentiment data with movie metadata; a profile processing system for collecting profile data for each viewer, correlating sentiment data with collected profile data, and clustering viewers into clusters based on collected profile data and time synchronized sentiment data; an evaluation system for predicting future success of the movie by analyzing the time synchronized sentiment data; and a recommendation system for recommending other movies to the viewers based on clusters.

### TECHNICAL FIELD

The subject matter of this invention relates to analysis of video content and more particularly to a system and method of providing real-time view analysis of movies using sensor data.

### BACKGROUND

Movie theaters continue to be a major entertainment attraction for people worldwide. The ability to rate and evaluate movies however remains an inexact science. Typically, movies are rated based on feedback from viewers who answer questions at screenings or electronically post comments and ratings in an on-line setting.

Unfortunately, this approach has numerous drawback. Firstly, the feedback may take days or weeks to accrue and does little to assist theaters in planning what to show in the immediate future. Secondly, different segments of people have different likes and dislikes, so overall reviews or ratings are not always helpful. Finally, reviews and ratings do little to assist in future productions by failing to help answer why a movie was successful or not successful.

### SUMMARY

Aspects of the disclosure provide a real-time viewer analysis engine that: (1) collects sensor data from users watching a movie; (2) tags movie portions with the viewers' emotional, behavioral, facial and biometric responses to classify content with populous counts, sentiment intensity and duration; and (3) analyzes the information to predict success, provide scene-based feedback for producers, segment viewers based on profile, and generate viewer recommendations for other movies.

A first aspect discloses a method for analyzing movie viewer reactions, including: capturing reaction information using multiple sensor inputs for each viewer in a group of viewers watching a movie; determining sentiment data from the reaction information, wherein the sentiment data includes a calculated intensity; correlating sentiment data with collected profile data for each viewer; time synchronizing sentiment data with movie metadata; clustering viewers into clusters based on collected profile data and time synchronized sentiment data; predicting future success of the movie by analyzing the time synchronized sentiment data; and recommending other movies to the viewers based on clusters.

A second aspect discloses a system for analyzing movie viewer reactions, comprising: a theater having a plurality of seats, wherein each seat includes an associated reaction collection system for capturing reaction information using multiple sensor inputs for a viewer watching a movie; a system for identifying sentiment data from the reaction information for a plurality of viewers; a system for time synchronizing sentiment data with movie metadata; a profile processing system for collecting profile data for each viewer, correlating sentiment data with collected profile data, and clustering viewers into clusters based on collected profile data and time synchronized sentiment data; an evaluation system for predicting future success of the movie by analyzing the time synchronized sentiment data; and a recommendation system for recommending other movies to the viewers based on clusters.

A third aspect discloses a computer program product stored on a computer readable storage medium, which when executed by a computing system, provides analysis of viewers watching a movie, the program product includes: program code that captures reaction information from multiple sensor inputs for each viewer in a group of viewers watching a movie; program code that identifies sentiment data from the reaction information; program code that correlates sentiment data with collected profile data for each viewer; program code that time synchronizes sentiment data with movie metadata; program code for clustering viewers into clusters based on collected profile data and time synchronized sentiment data; program code for predicting future success of the movie by analyzing the time synchronized sentiment data; and program code recommending other movies to the viewers based on clusters.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a theater according to embodiments.

FIG. 2 shows an overview of a viewer analysis engine according to embodiments.

FIG. 3 shows a computing system having a viewer analysis system according to embodiments.

FIG. 4 shows a flow diagram of implementing a viewer analysis system.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

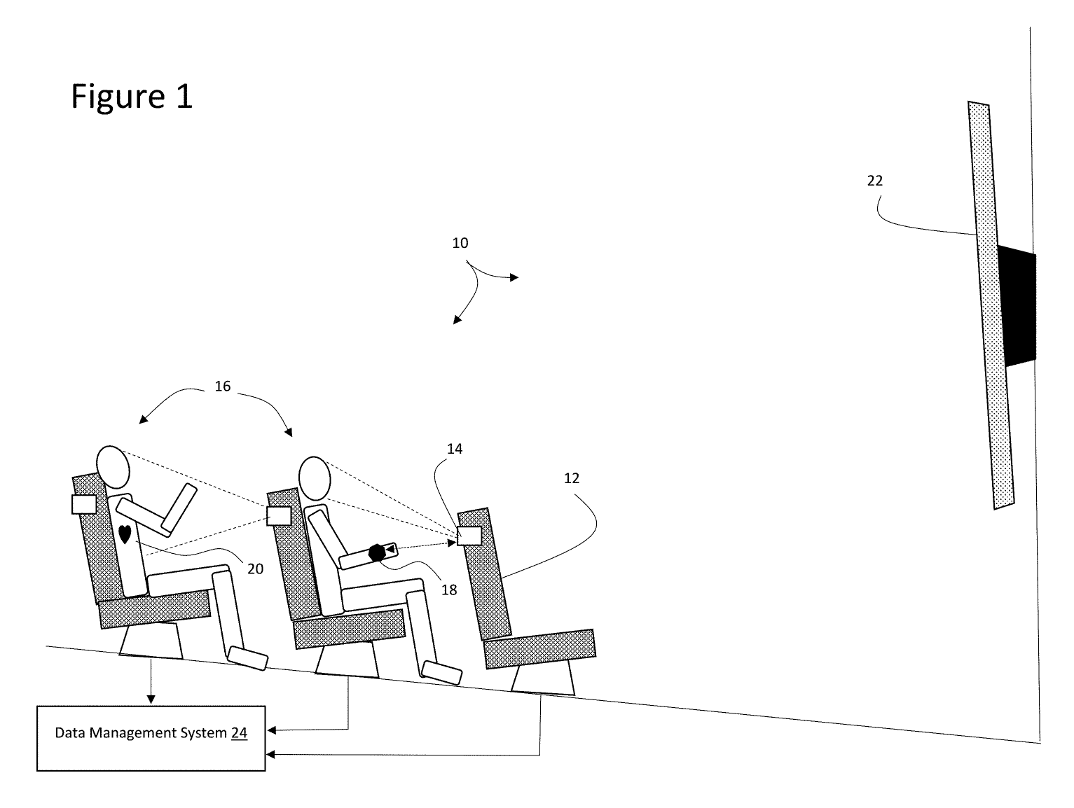

Referring now to the drawings, FIG. 1 depicts a theater 10 configured to collect different types of sensor information from a group of viewers 16 viewing a movie (or other content) on a screen. In the illustrative embodiment shown, each seat 12 is configured with a reaction collection system 14 that is adapted to collect multiple types of reactions from each viewer 16 via one or more sensor inputs. For example, reaction collection system 14 may incorporate an eye tracking image sensor to collect and analyze eye-tracking data, an image system to collect and analyze facial expressions, body movements, laughter, clapping, booing, boredom, etc. In addition, reaction collection system 14 may be adapted with a wireless system such as Bluetooth® to link with a user App, e.g., via a smartwatch 18, wearable 20 or smartphone (not shown), and collecting information such as heartrate, body temperature, tactile responses, etc. As the reaction information is collected, it is captured and stored in a data management system 24, which may be located in the theater or elsewhere. Data management system 24 tracks a viewer identifier (e.g., which seat 12 the information came from, user information, profile data, etc.) for each viewer in the theater, timing information (e.g., when reaction were collected, etc.), and associated sensor data (e.g., reaction type, measurements, intensities, etc.). Full or partial analysis of collected sensor data may be done by the reaction collection system 14, by the data management system 24 and/or via a separate system (not shown in FIG. 1).

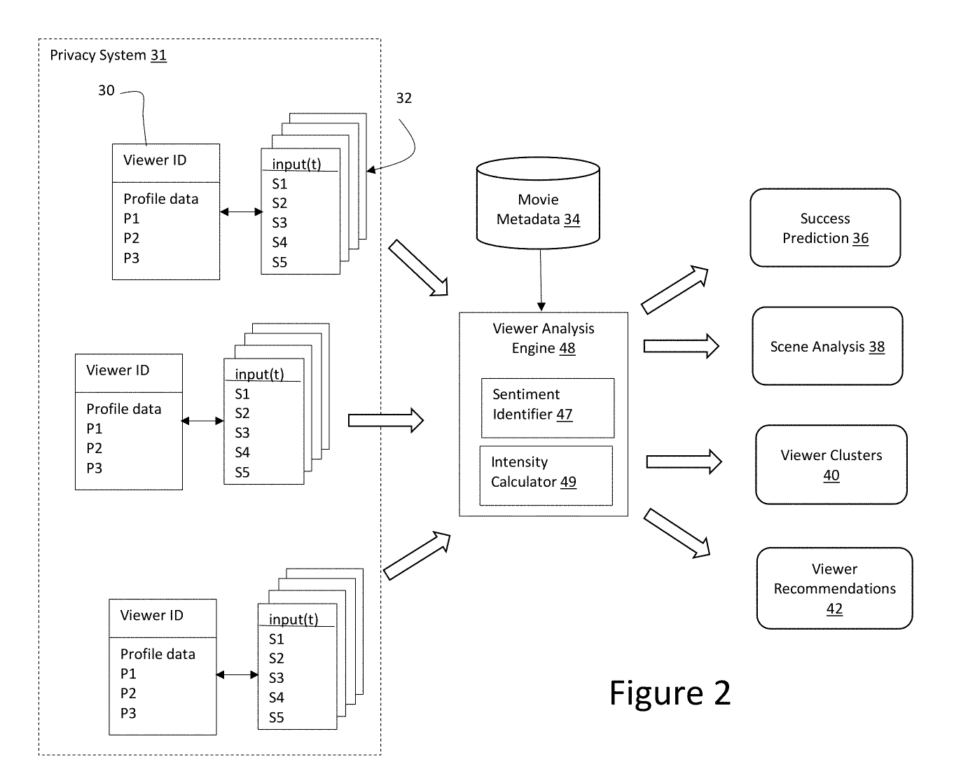

FIG. 2 depicts an illustrative embodiment of a real-time viewer analysis engine 48 that processes collected reaction information and provides various outputs based on identified viewer sentiments and user profiles. In this example, reaction information includes viewer information 30 that, e.g., includes (a) a viewer ID and profile data; and (b) sensor inputs 32. In a simple case, the viewer information 30 may include just a unique ID, such as a seat number. In more complex embodiments, the viewer information 30 may include profile data of the viewer, such as P1=age, P2=sex, P3=movie interests, etc. Profile data may be obtained in any manner, e.g., when tickets are booked online at a point of sale system, or via a connected App the viewer is running on their smart device, etc. In addition, assuming the viewer consents, facial recognition may be used to identify the viewer. Public profiles from Facebook, WhatsApp, etc., may then be utilized to generate profile data from identified patrons. Regardless, a privacy system 31 may be employed to protect personal information and allow viewers to opt in or out of any one or more features. For example, a viewer may be allowed to disable/enable aspects of the reaction collection system 14 (FIG. 1), configure privacy settings in a user App, etc. Further, privacy system 31 may be configured to avoid storing any private information, such as a user identity once the profile data is determined. In exchange for allowing for the collection of reaction information, the viewer may receive some benefit, such as reduced price, coupons, recommendations, etc.

Sensor inputs 32 may for example comprise reaction information from different sensors, e.g., S1=eye data; S2=facial expression data; S3=heartrate data; S4=clapping data; S5=leg movement data. Each sensor input is tracked over a time t, i.e., input(t). Inputs may be tracked in any manner, e.g., in a continuous fashion, by scene, by time segments, etc. All of the reaction information is fed into analysis engine 48, which identifies sentiments (via sentiment identifier 47) by processing sensed reactions, emotions, interest levels, intensity, facial expressions, movements, etc., for each portion of the movie for all the viewers. In one illustrative embodiment, sensor inputs 32 for a group of users over a given time period are fed into a machine learning system, which calculates one or more sentiments (e.g., happy, excited, bored, scared, etc.).

Additionally, movie metadata 34 provides timing and other information from the movie, e.g., timing information such as start time, stop time, etc., scene sequences, scene actors, scene type, etc., which is time synchronized with the sentiment data. For example, analysis engine 48 may process the fact that a majority of the viewers jumped out of their seat at a given point, identify a sentiment (e.g., very scared, excited, etc.), and correlate the sentiment with a portion/scene in the movie.

Accordingly, different portions, scenes, times of the movie will be time synchronized with one or more sentiments (e.g., emotion levels, interest levels, etc.) based on the behavior of the group of users. For example, a particular portion (e.g., starting at 10:15:20 and ending at 10:16:25) may have 45% of viewers in an excited cheering mood, and another 80% of the viewers clapping. Sentiment identifier 47 may tag the portion with a “happy/excited” sentiment. An intensity calculator 49 may be utilized to assign an intensity to an identified sentiment, e.g., by counting the number of viewers having a similar reaction, by measuring the duration of the reaction, by measuring the intensity of the reaction, etc. In one example, a scale of 1-10 may be utilized with 10 being the most intense. A resulting real-time analysis of the movie may be captured in the form:
Movie=<Title>
   Number of viewers=<number>
   Sequence 1:
      Sentiment=<Happy>
      Intensity=3
   Sequence 2:
      Sentiment=<Bored>
      Intensity=5
Etc.

Once the sentiment data is calculated, various real-time outputs can be generated, including, e.g., success prediction 36, scene analysis 38, viewer clusters 40, viewer recommendations 42, etc.

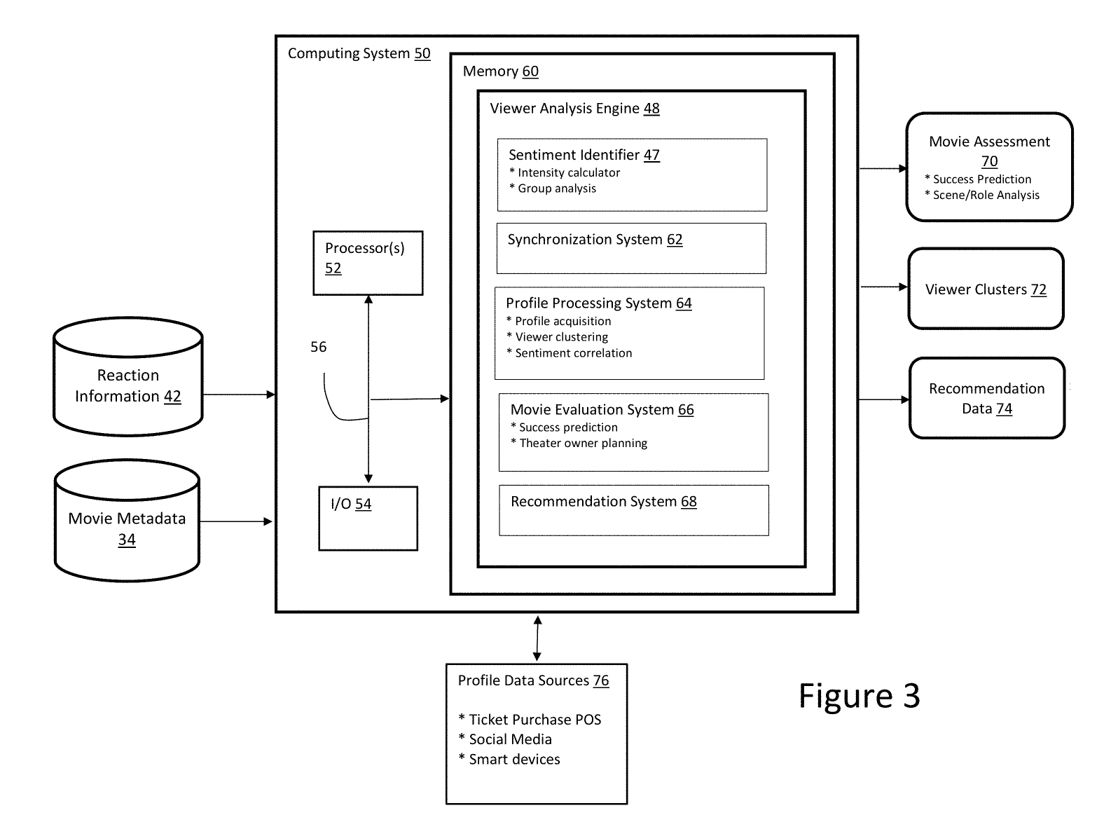

FIG. 3 depicts an illustrative computing system 50 for implementing viewer analysis engine 48 using reaction information 42, movie metadata 34, and profile data sources 76.

As shown, viewer analysis engine 48 includes: a sentiment identifier 47 that analyzes group oriented reaction information 42 to identify sentiments and calculate associated intensities, a synchronization system 62 that time synchronizes sentiments with movie metadata 34 (e.g., timing, scenes, actors, roles, etc.); profile processing system 64 that provides profile acquisition, viewer clustering (i.e., viewer segments) and correlation of identified sentiments with profiles; movie evaluation system 66 that outputs a movie assessment 70 that, e.g., includes success prediction and scene/role analysis; and a recommendation system 68 that provides movie recommendation data 74 for viewers, e.g., based on cluster/sentiment analysis.

In this embodiment, profile processing system 64 acquires profile data from one or more profile data sources, e.g., ticket purchase point of sale (POS), facial recognition, social media, smart devices, etc. Based on profile data and correlated sentiment data collected for different viewers, viewers can be segmented into different clusters, e.g., viewer with high emotional responses, millennials who enjoy comedy, college age viewers who enjoy science fiction, etc. Viewer clusters 72 can be used to, e.g., understand who liked/dislike the current movie, market to particular segments, create communities, etc.

Movie evaluation system 66 provides real-time interest level information of viewers, and predicts success which theater owners can use to plan showings in coming days. For example, owners can plan the number of showings to be shown in coming days based upon predicted success calculated on the first day. For instance, an overall sentiment score can be calculated for the movie, and further break down sentiment scores by cluster. Sentiment scores may for example comprise different components, such as:
a. Boredom Score—8
b. Excitement Score—2
c. Humor Score—5
d. Engagement Score—6
TOTAL SCORE=6
   Components scores (along with profile data) can for example be fed into an artificial intelligence system, such as a neural network, to output: an overall success prediction, predictions based on clusters, predicted ticket sales/revenue, predicted performance based on time of showing, marketing strategies, etc.

Movie assessment 70 may also include feedback for movie production teams as for various aspects (i.e., scenes, scene types, actors, roles, scene length, etc.) of the movie, thus helping improve future productions.

Recommendation system 68 and associated recommendation data 74 may likewise provide real-time feedback for the viewers. Since each seat assigned to a viewer will have associated profile data, e.g., collected during booking, from a smart-watch, etc., movies can be recommended to viewers based upon similar personalized profiles and response to other movies. For example, suppose a viewer was very excited during particular portions of the movie. Other viewers can be identified (as a cluster) who also show similar types of sentiments for the same portions of the same movie, and who share the same demographic profile. Recommendation system 68 can recommend movies cluster members like (based on profile data) to other members of the cluster.

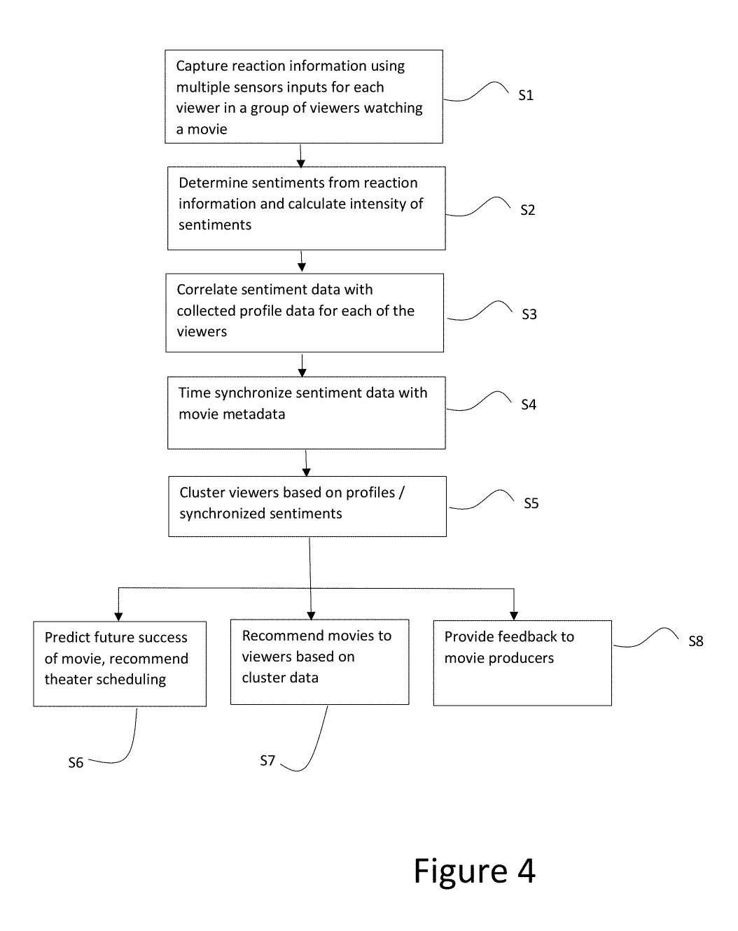

FIG. 4 depicts an illustrative process for implementing viewer analysis system 48 (FIGS. 2 and 3). At S1, reaction information 42 is captured using multiple sensor inputs for each viewer in a group of viewers watching a movie. At S2, sentiments from the reaction information are determined, and associated intensities of the sentiments are calculated. At, S3, sentiment data is correlated with collected profile data for each of the viewers. At S4, the sentiment data is time synchronized with the movie metadata 34, and at S5, viewers are clustered based on profiles and time synchronized sentiments (e.g., male viewers who cried during a given scene could form a cluster). Clusters can also be formed with viewers watching the same movie in different theaters or at different times, or with viewers watching other movies.

Either during or immediately after the movie has been shown to the group of viewers, future success of the movie is predicted at S6. For example, based on the intensity of the sentiments and viewer profiles, a machine learning system may be implemented to predict the number of future ticket sales the theater can expect to make. Predicted ticket sales may be further broken down by demographics, e.g., age, sex, etc. Recommended theater show time scheduling may also be generated based on the sentiments and viewer profiles, e.g., ticket sales will be maximized if the movie is shown during weekend days when families bring their children.

Additionally, during the movie, immediately after, or a later time, other movies can be recommended to the viewers based on cluster data at S7. Further, at S8, time synchronized feedback can be provided to movie producers, e.g., to provide a scene by scene analysis of collected sentiments.

It is understood that viewer analysis engine 48 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 50 (FIG. 3) may comprise any type of computing device and for example includes at least one processor 52, memory 60, an input/output (I/O) 54 (e.g., one or more I/O interfaces and/or devices), and a communications pathway 56. In general, processor(s) 52 execute program code which is at least partially fixed in memory 60. While executing program code, processor(s) 52 can process data, which can result in reading and/or writing transformed data from/to memory and/or I/O 54 for further processing. The pathway 56 provides a communications link between each of the components in computing system 50. I/O 14 can comprise one or more human I/O devices, which enable a user to interact with computing system 50. Computing system 50 may also be implemented in a distributed manner such that different components reside in different physical locations.

Furthermore, it is understood that the viewer analysis engine 48 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method for analyzing movie viewer reactions, comprising:
capturing reaction information using multiple sensor inputs for each viewer in a group of viewers watching a movie;
determining sentiment data from the reaction information, wherein the sentiment data includes a calculated intensity;
correlating sentiment data with collected profile data for each viewer;
time synchronizing sentiment data with movie metadata;
clustering viewers into clusters based on collected profile data and time synchronized sentiment data;
predicting a future success of the movie for different clusters of viewers by analyzing the time synchronized sentiment data, the predicted future success including an estimate of future ticket sales for the movie;
generating a recommended future show time schedule of the movie based on the predicted future success of the movie for the different clusters of viewers; and
recommending other movies to the viewers based on clusters.

2. The method of claim 1, further comprising generating feedback that includes sentiment data for each scene in the movie.

3. The method of claim 1, wherein the sensor inputs include eye-tracking and body movement collected from an image detection system.

4. The method of claim 3, wherein the sensor inputs further include at least one of a heart rate or a tactile response collected from at least one of a smartwatch, smartphone, or wearable.

5. The method of claim 1, wherein collected profile data is determined using facial recognition.

6. The method of claim 1, wherein collected profile data is determined by a ticket point of sale system.

7. (canceled)

8. A system for analyzing movie viewer reactions, comprising:
a theater having a plurality of seats, wherein each seat includes an associated reaction collection system for capturing reaction information using multiple sensor inputs for a viewer watching a movie;
a system for identifying sentiment data from the reaction information for a plurality of viewers;
a system for time synchronizing sentiment data with movie metadata;
a profile processing system for collecting profile data for each viewer, correlating sentiment data with collected profile data, and clustering viewers into clusters based on collected profile data and time synchronized sentiment data;
an evaluation system for predicting a future success of the movie for different clusters of viewers by analyzing the time synchronized sentiment data, the predicted future success including an estimate of future ticket sales for the movie; and
a system for generating a recommended future show time schedule of the movie based on the predicted future success of the movie for the different clusters of viewers.

9. The system of claim 8, wherein the evaluation system generates feedback that includes sentiment data for each scene in the movie.

10. The system of claim 8, wherein the reaction collection system includes an image detection system that captures eye-tracking and body movement.

11. The system of claim 8, wherein the reaction collection system includes collecting at least one of a heart rate or a tactile response collected from at least one of a smartwatch, smartphone, or wearable.

12. The system of claim 8, wherein collected profile data is determined using facial recognition.

13. The system of claim 8, wherein collected profile data is determined by a ticket point of sale system.

14. The system of claim 8, wherein the recommended future show time schedule of the movie specifies days of the week and times of the day.

15. A computer program product stored on a computer readable storage medium, which when executed by a computing system, provides analysis of viewers watching a movie, the program product comprising:
program code that captures reaction information from multiple sensor inputs for each viewer in a group of viewers watching a movie;
program code that identifies sentiment data from the reaction information;
program code that correlates sentiment data with collected profile data for each viewer;
program code that time synchronizes sentiment data with movie metadata;
program code for clustering viewers into clusters based on collected profile data and time synchronized sentiment data;
program code for predicting a future success of the movie for different clusters of viewers by analyzing the time synchronized sentiment data, the predicted future success including an estimate of future ticket sales for the movie; and
program code for generating a recommended future show time schedule of the movie based on the predicted future success of the movie for the different clusters of viewers.

16. The program product of claim 15, further comprising generating feedback that includes sentiment data for each scene in the movie.

17. The program product of claim 15, wherein the sensor inputs include eye-tracking and body movement collected from an image detection system.

18. The program product of claim 15, wherein the sensor inputs include at least one of a heart rate or a tactile response collected from at least one of a smartwatch, smartphone, or wearable.

19. The program product of claim 15, wherein collected profile data is determined using facial recognition.

20. The program product of claim 15, wherein collected profile data is determined by a ticket point of sale system.
